(19) United States
(12) Patent Application Publication
(10) Pub. No.: US 2009/0050267 A1
(43) Pub. Date: Feb. 26, 2009

(54) Customizable item labeling system for use in manufacturing, packaging, product shipment-fulfillment, distribution, and on-site operations, adaptable for validation of variable-shaped items

(75) Inventors: Kevin M. Conlon, Berthoud, CO (US); Bruce A. Johnson, Grand Junction, CO (US); Michael J. Baranello, Denver, CO (US); Josh Van Riper, Berthoud, CO (US)

Correspondence Address: JEAN M. MACHELEDT, 501 SKYSAIL LANE, SUITE B100, FORT COLLINS, CO, 80525-3133, US

(73) Assignee: Maverick Enterprises, Inc.

(21) Appl. No.: 12/228,358

(22) Filed: Aug. 11, 2008

Related U.S. Application Data
(60) Provisional application No. 60/964,286, filed on Aug. 11, 2007.

(51) Int. Cl. C09J 5/00

(52) U.S. Cl. 156/312; 156/538; 156/379

(57) ABSTRACT

A system for labeling a plurality of items, each having a periphery. The system has: a rotary-station comprising a pair of plate-members each having a rotation axis, the pair of plate-members is adapted for holding each of the plurality of items, individually; a labeler assembly for providing a plurality of dedicated labeling; a mechanism for applying a labeling-edge of a dedicated labeling created for a first item of the plurality of items, leaving a first labeling tail, while holding the first item between the pair of plate-members; and a roller for contouring the first labeling tail around at least a portion of the periphery of the first item by making contact between a rolling surface and the first labeling tail while the first item moves in a spinning fashion between the pair of plate-members. The system may incorporate a single-rotary station unit or a multi-rotary station unit. An associated method of labeling a plurality of items is also disclosed.

This application claims priority to pending U.S. provisional patent app. 60/964,286 filed 11 Aug. 2007 on behalf of the assignee hereof for the four applicants hereof. To the extent consistent with the subject matter set forth herein, provisional app. 60/964,286 is hereby fully incorporated, herein, by reference for background and full technical support.

### BACKGROUND OF THE INVENTION

### Field of the Invention

In general, the present invention relates to systems for identifying, labeling, and tracking individual product-items or packages moving through a production, manufacturing, packaging, shipment-fulfillment or distribution assembly line. More-particularly, the invention is directed to a new system and associated unique method for automatically applying labeling, for release/validation and tracking purposes, to each of a plurality of items, whether of similar shapes and sizes or of a variety of shapes and sizes, that have been selected from one or more bins in automatic or manual pick-and-place fashion, or traveling in assembly-line fashion from an earlier line operation, or dropped or fed into place manually, and so on.

Items enter the new system at a holding-nest station or staging area. The length of time spent in staging is not critical, and may be a fraction of a second or much longer depending upon whether a pick-and-place machine is presenting item(s) or items are manually loaded from bins or other storage, and such. Each item then passes through an assembly of components that perform a labeling+contouring functionality, and a further-unique auto-visual inspection functionality (which may be performed on-site or remotely), before exiting and being transported to a subsequent destination within, and/or out of, the facility within which the assembly line resides. The labeling+contouring functionality comprises preferably, either: (A) a multi-rotary station unit having a labeling-affixation station, where at least one labeling is tangentially affixed to each item according to character of the item and/or its contents, and then on to and through a labeling contour and application station; or (B) a single-rotary station unit with labeling-affixation and contouring uniquely performed at a designated station.

By way of example, each of the plurality of ‘items’ may include, without limitation, any of a wide variety of one or more similar or different products and the packages/packaging used for containing/clustering together one or more smaller objects, that may benefit from identification through a labeling: ‘products’ is contemplated to include items such as handheld devices, cell phones, compact disks (CD/DVD/etc.) and other recording/storage media (magnetic and otherwise), as well as books, magazines, newspapers, prepared/packaged foodstuff and other products, produced or manufactured in quantity, whether in assembly line fashion; and ‘packages/packaging’ used for containing or otherwise clustering together one or more smaller objects for transport is contemplated to include bottles, boxes, packets, pouches, tubes, envelopes, baggies, flexible-wrap, fusion material, cans/canisters, blister-packs, vacuum-formed packs, recording/storage media cases, and other such packaging and containment shapes.

The new system and method for labeling is adaptable for accommodating items of a variable shapes and sizes, on the fly. The labeling applied, in cooperation with a bar code reader/labeling validation apparatus, provides an item labeling and verification tool for assembly line operations (with or without a common carrier/receptacle/tote) or subsequent on-site item verification. Regardless of shape, size, or construction, and whether the items moving through the line are contained atop the conveyer or within a common carrier/tote, labeling is applied and validated/verified by the apparatus automatically, before being deposited into a subsequent station within the assembly line, or collected into an external shipment container—such as a larger envelope, box, bag, exterior-wrap, tub, and so on—bound for a selected destination.

General purpose labeling and product tracking systems. Conventional labeling systems, including prior systems owned by the assignee hereof and invented by at least one applicant hereof, typically apply a preprinted label that is either manually or automatically applied to a product or its packaging prior to being released into the fulfillment or distribution process/assembly line. Products or packaging are placed within a tote based upon desired criteria, such as each going to the same end-destination as is shown in U.S. patent application Ser. No. 10/382,164 filed 4 Mar. 2003 for “Automated Packing System” incorporated herein by reference for its detailed technical background discussion of an innovation of one applicant hereof, while obligated under an assignment to the assignee hereof. The products in a tote often require verification and validation, for example, see pp. 25/54-26/54 of application Ser. No. 10/382,164

Additionally, by way of further general background reference only: U.S. Pat. No. 5,771,657 discusses an auto-prescription filling, sorting and packaging system incorporating an assembly line to label bottles into which pills have been dispensed; PCT International application published as No WO 94/16902 on 4 Aug. 1994 entitled “TECHNIQUE FOR LABELING AN OBJECT FOR ITS IDENTIFICATION AND/OR VERIFICATION” and U.S. Pat. No. 5,194,289 granted 16 Mar. 1993 entitled “METHOD FOR LABELING AN OBJECT FOR ITS VERIFICATION” discuss labeling techniques; PCT International application published as No WO 03/104780 A1 on 18 Dec. 2003 entitled “LABEL INSPECTION METHOD AND LABEL INSPECTION DEVICE” originating from a Japanese patent application, has an example of a labeling scheme; and radio frequency (RF) identification tags are known to have been adopted for limited use in material tracking and verification.

Typically, product identification labels have an opaque barcode with various styled identifiers. It is very difficult to apply labeling, in automatic fashion, to product-items that are odd-shaped, or of a variety of shapes, and have no guaranteed orientation while moving along the conveyor/assembly line.

### Computerized Devices, Memory & Storage Devices/Media.

I. Digital computers. A processor is the set of logic devices/circuitry that responds to and processes instructions to drive a computerized device. The central processing unit (CPU) is considered the computing part of a digital or other type of computerized system. Often referred to simply as a processor, a CPU is made up of the control unit, program sequencer, and an arithmetic logic unit (ALU)—a high-speed circuit that does calculating and comparing. Numbers are transferred from memory into the ALU for calculation, and the results are sent back into memory. Alphanumeric data is sent from memory into the ALU for comparing. The CPUs of a computer may be contained on a single ‘chip’, often referred to as microprocessors because of their tiny physical size. As is well known, the basic elements of a simple computer include a CPU, clock and main memory; whereas a complete computer system requires the addition of control units, input, output and storage devices, as well as an operating system. The tiny devices referred to as ‘microprocessors’ typically contain the processing components of a CPU as integrated circuitry, along with associated bus interface. A microcontroller typically incorporates one or more microprocessor, memory, and I/O circuits as an integrated circuit (IC). Computer instruction(s) are used to trigger computations carried out by the CPU.

II. Computer Memory and Computer Readable Storage. While the word ‘memory’ has historically referred to that which is stored temporarily, with storage traditionally used to refer to a semi-permanent or permanent holding place for digital data—such as that entered by a user for holding long term—more-recently, the definitions of these terms have blurred. A non-exhaustive listing of well known computer readable storage device technologies are categorized here for reference: (1) magnetic tape technologies; (2) magnetic disk technologies include floppy disk/diskettes, fixed hard disks (often in desktops, laptops, workstations, etc.), (3) solid-state disk (SSD) technology including DRAM and ‘flash memory’; and (4) optical disk technology, including magneto-optical disks, PD, CD-ROM, CD-R, CD-RW, DVD-ROM, DVD-R, DVD-RAM, WORM, OROM, holographic, solid state optical disk technology, and so on.

### SUMMARY OF THE INVENTION

Briefly described, in one characterization, the invention is directed to aspects of a new system and associated unique method for automatically applying labeling, for validation and tracking purposes, to each of a plurality of items, whether of similar shapes and sizes or of a variety of shapes and sizes, that have been selected from one or more bins in automatic or manual pick-and-place fashion, or traveling in assembly-line fashion from an earlier line operation, or dropped or fed into place, and so on.

### BRIEF DESCRIPTION OF DRAWINGS

For purposes of illustrating the innovative nature plus the flexibility of design and versatility of the new system and associated technique set forth herein, the following background references and figures are included. One can readily appreciate the advantages as well as novel features that distinguish the instant invention from conventional labeling systems and techniques. Where similar components are represented in different figures or views, an effort has been made to use the same/similar reference numbers for purposes of consistency. The figures as well as any incorporated technical materials have been included to communicate the features of applicants' innovative device and technique by way of example, only, and are in no way intended to limit the disclosure hereof. Any enclosure identified and labeled an ATTACHMENT, is hereby incorporated herein by reference for purposes of providing background technical information.

FIGS. 1A, 1B, and 1C are high level flow diagrams schematically representing a system and method including a loading station, 100 (and/or 140, 190) for staging items, consecutively, (e.g., 130, 132) for locating on a rotary station such as 200 for processing through a multi-rotary station unit, or through alternative-preferred route 400 for processing though a single-rotary station unit, and eventually on to 380. FIG. 1A details focus on the front-end of the system, while FIG. 1B features the unique multi-rotary station unit (200, 280, 300) and the unique single-rotary station unit (400); with FIG. 1C detailing features of the back-end of the system, the auto-visual inspection functionality (which may be performed on-site or remotely), whereby image capture records made 331 are utilized in automated fashion to provide a unique remote-release/validation 389 of a labeled item.

FIG. 2 is an isometric of a system having an automated pick-and-place functionality 100 and a labeling application+contouring functionality 400 (see also, FIGS. 1, 4, and 8) with portions of the covering over the system apparatus removed.

FIG. 3 is an isometric of the automated pick-and-place functionality 100 shown in FIG. 2, permitting viewing the robot mechanism.

FIG. 4 is a plan view looking-in along 4-4 of FIG. 2 permitting viewing of features within the labeling and contouring functionality stations.

FIG. 5 is an isometric of a component identified as a Roller System 414.

FIG. 6 is an isometric of a component identified as a Backstop Assembly with a backstop plate-shaped object at 412.

FIG. 7 is an isometric of a component identified as a Rotary Station with a rotary head plate-shaped object at 418.

FIG. 8 is an isometric of the selection of components for a single-rotary station labeling application+contouring functionality 400 (see also, FIG. 1) shown also in front plan view in FIG. 4.

FIG. 9 is an isometric of an alternative preferred system (with no automated pick-and-place functionality shown, such as is represented elsewhere at 100 or 140) having a multi-rotary station labeling application+contouring functionality (see also, FIG. 1 at 200, 300, 331) with portions of the covering over the system apparatus removed.

FIG. 10 is a plan view looking-in on the FIG. 9 system apparatus permitting viewing of features of the labeling and contouring functionality stations.

FIG. 11 is yet another plan view looking-in at the FIG. 10 system apparatus components permitting viewing of features of the labeling and contouring functionality stations.

FIG. 12 is an isometric of the selection of components (see also, FIGS. 9 through 11) identified as DIAL TABLE ASSEMBLY 540 having four rotary stations 520A-520D.

FIG. 13 is an isometric of the top subassembly of Rotary Station 520A.

FIG. 14 is an isometric of the selection of components (see also, FIGS. 9 through 11, and FIGS. 1A, 1B at 210) identified as a LABELER 510.

FIG. 15 is an isometric of a Roller system 514 having roller 515 with a free-rolling surface labeled, for reference, 515s.

FIG. 16 is an isometric of a SWEEPER 570.

FIG. 17 is an isometric of a System Rotary 560 (see also, FIG. 9).

FIG. 18A is a slightly enlarged isometric of a portion of FIG. 8 detailing the single-rotary station, along with an arrow representing the orientation 12′ of an item when undergoing the contouring functionality to contour a label tail around the item.

FIG. 18B schematically depicts several items 12, an axis shown for each, representing example shapes of the wide variety to which a labeling may be affixed.

FIG. 19A is a slightly enlarged isometric of a portion of FIG. 11 detailing one of the rotary stations (“STATION #3”, 520C), along with an arrow representing the orientation 14′ of an item when undergoing the contouring functionality to contour a label tail around the item.

FIG. 19B schematically depicts several items 14, an axis shown for each, representing example shapes of the wide variety to which a labeling may be affixed.

FIG. 19C schematically depicts a top plan view (taken at 19C-19C of FIG. 19B) of one of the items 14 having been labeled such that a ‘label flag’ results.

FIG. 20 is an isometric—in the form of a digital photo—of an alternate Rotary Station assembly 620A; for comparison, see FIGS. 10, 12, 13, and 19A at 520A-520D.

### DESCRIPTION DETAILING FEATURES OF THE INVENTION

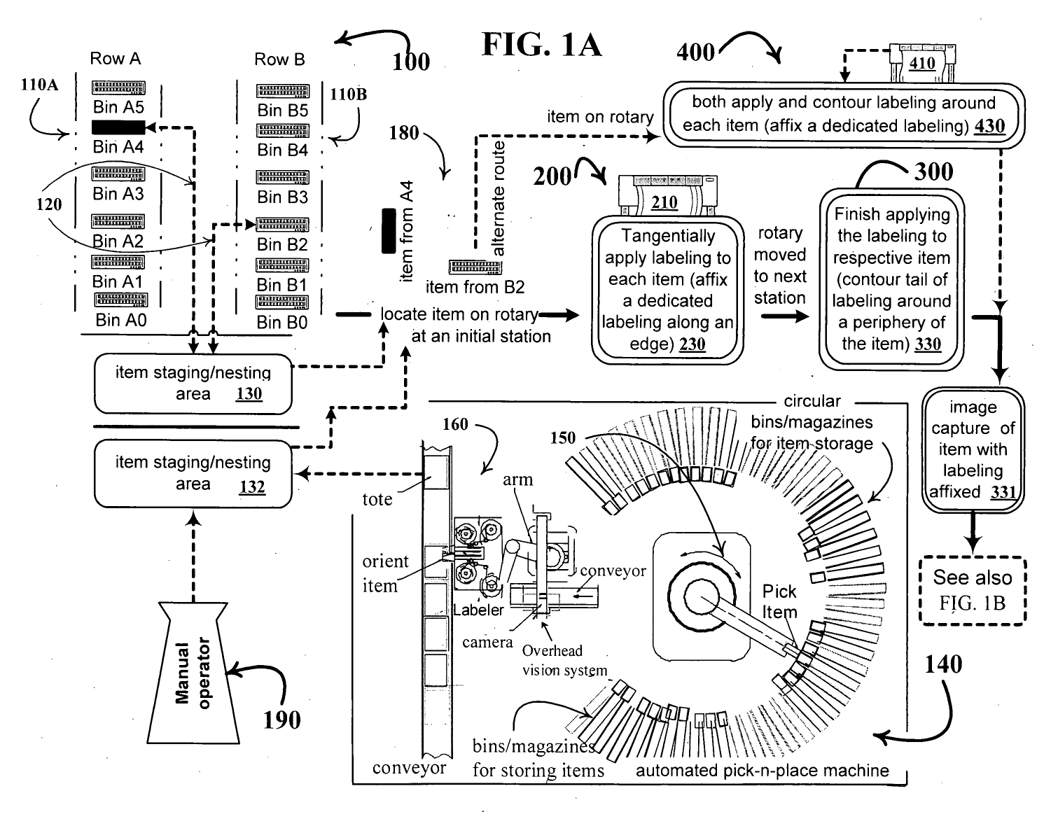

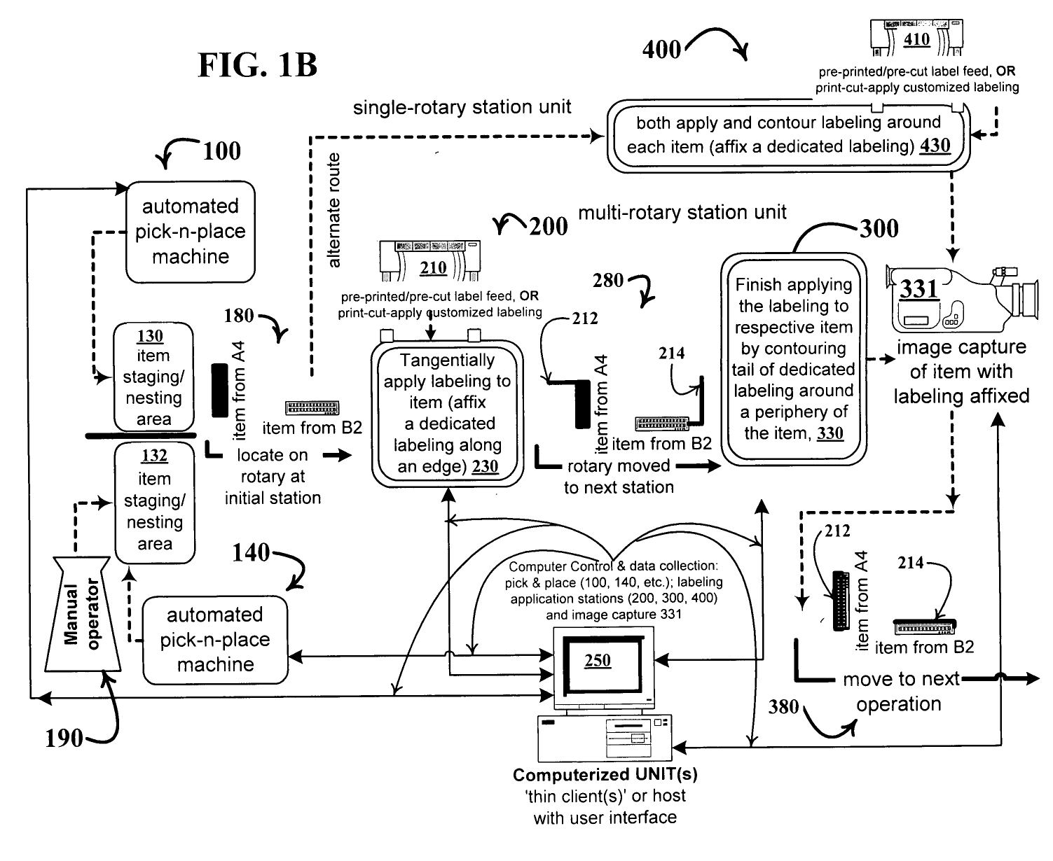

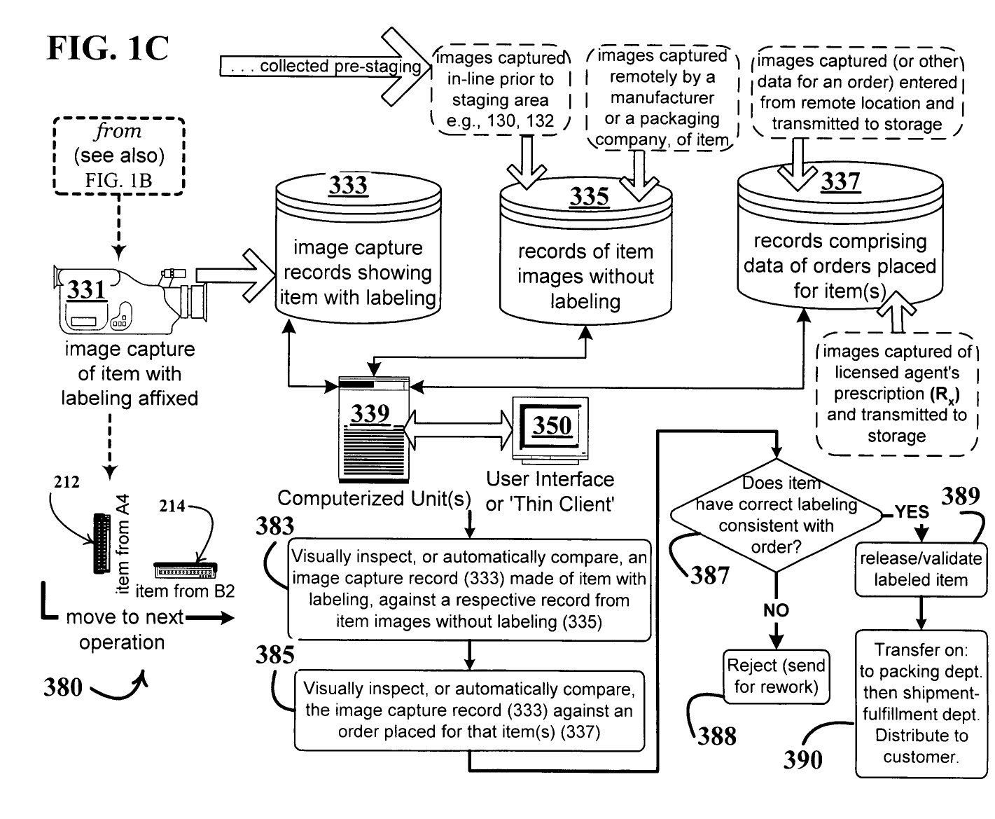

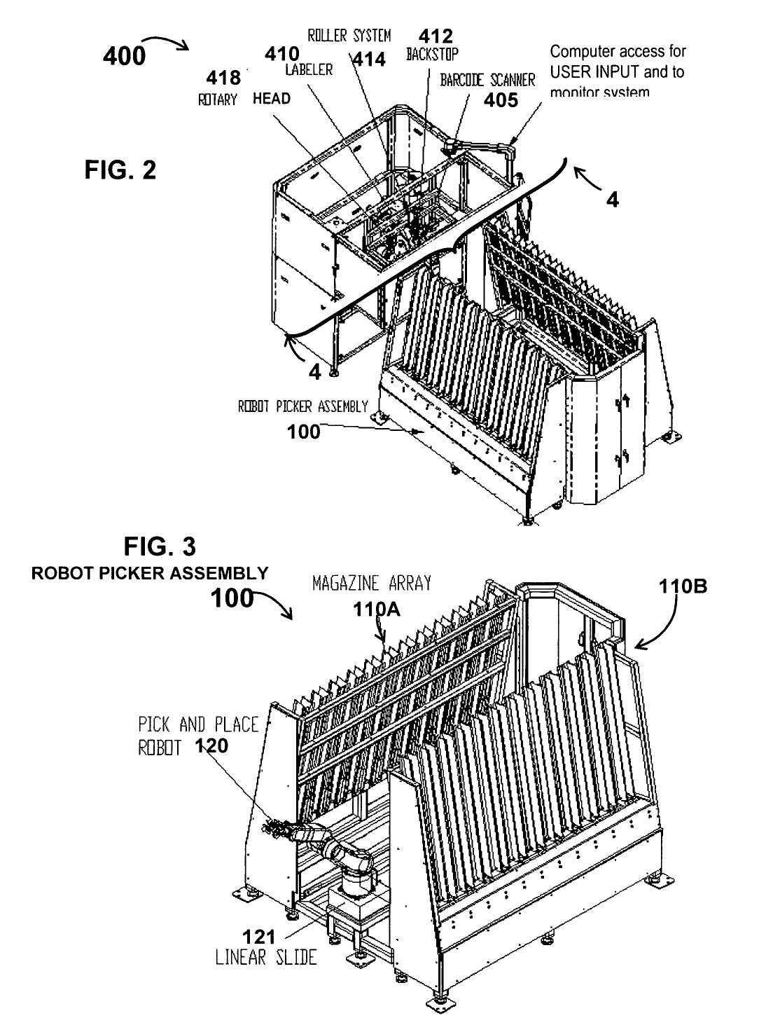

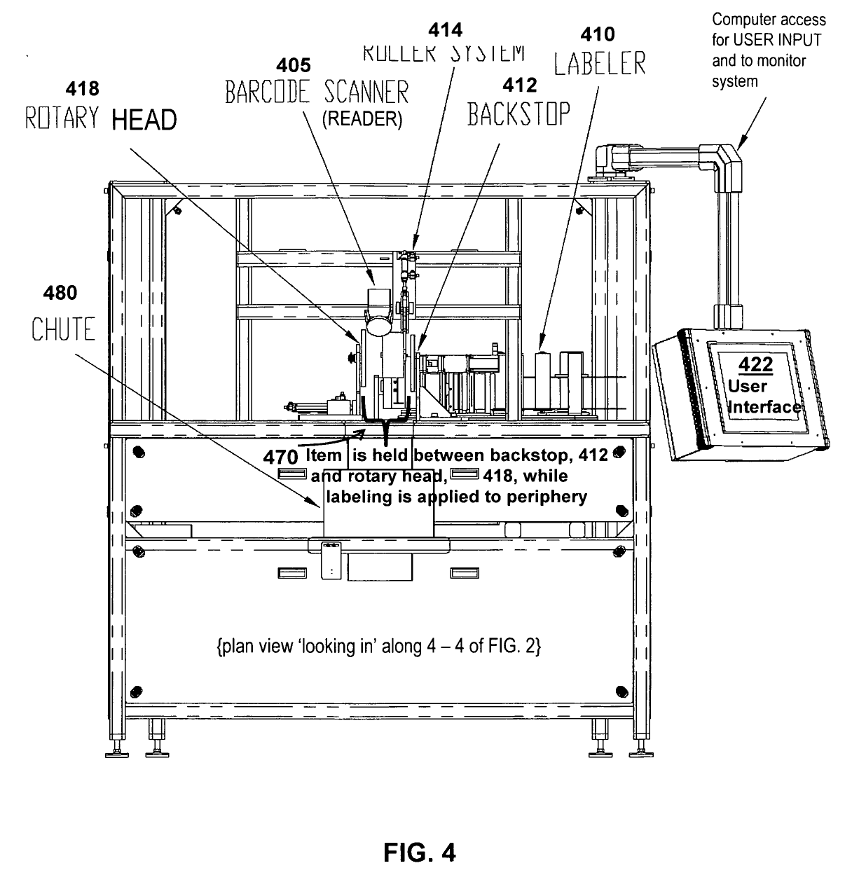

By viewing the figures which depict associated representative structural embodiments, one can further appreciate the unique nature of core as well as additional and alternative features of the new item labeling system and associated technique. Back-and-forth reference has been made to the various drawings—especially the schematic diagrams of FIGS. 1A, 1B, and 1C, and the system isometric views labeled FIGS. 2-3, 9-12, 18A, and 19A which detail core as well as additional features of the system and method. Such back-and-forth reference is done to associate respective features having commonality, providing a better overall appreciation of the unique nature of the item labeling system and method.

U.S. patent application Ser. No. 10/382,164 filed 4 Mar. 2003 for “Automated Packing System” incorporated herein by reference for its detailed background technical discussion of an automated packing system innovation of one applicant hereof, while obligated under an assignment to the assignee hereof.

FIGS. 1A, 1B, and 1C are high level flow diagrams schematically representing a system and method including a loading station, 100 (and/or 140, 190) for staging items, consecutively, (e.g., 130, 132) for locating on a rotary station such as 200 for processing through a multi-rotary station unit, or through alternative-preferred route 400 for processing though a single-rotary station unit, and eventually on to 380. FIG. 1A details focus on the front-end of the system, while FIG. 1B features the unique multi-rotary station unit (200, 280, 300) and the unique single-rotary station unit (400); with FIG. 1C detailing features of the back-end of the system, the auto-visual inspection functionality (which may be performed on-site or remotely), whereby image capture records made 331 are utilized in automated fashion to provide a unique remote-release/validation 389 of a labeled item. Illustrated are core, as well as further distinguishing/additional, features of the invention for labeling a plurality of items such as those represented and/or depicted in the other figures.

Beginning with FIG. 1A, as represented by 100, 140, 190: items may be stored in a variety of configurations—such as bins/magazines as rows in-parallel 100 or built into a circular magazine rack 140 or simply contained in a receptacle for placement by an operator 190—before being loaded or ‘located’ at an initial rotary station 180. While two different automated pick-and-place configurations are shown 100, 140, any of a number of automated ‘robotic’ placement machinery configurations and styles may be employed to locate individual items at an initial rotary station 180 for labeling. For reference, a staging/nesting area has been defined 132, 130 as an ‘entry point’ for items moving from storage or a prior in-line operation and into position at a rotary station 180. Such storage may be longer-term (such as placed in bin locations of magazine arrays 110A, 110B) or a more-temporary storage, for example although not shown in detail, the items may be rolling off a prior in-line packaging/container-print operation 140 and into a receptacle that orients the axis of each item before it is picked up 132 by a robot arm or human 190 and located in a rotary station 180.

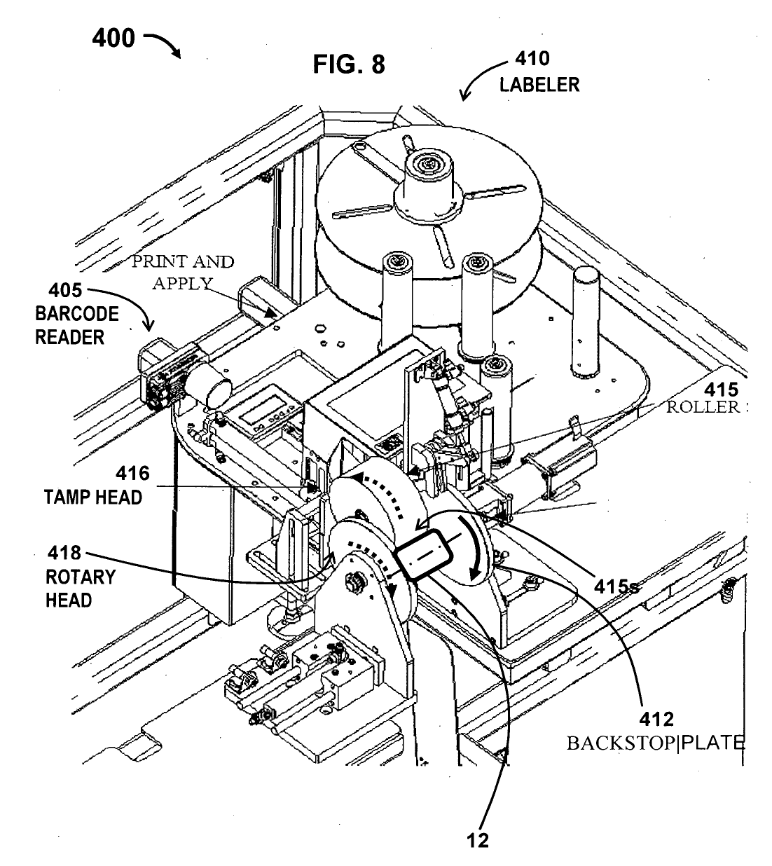

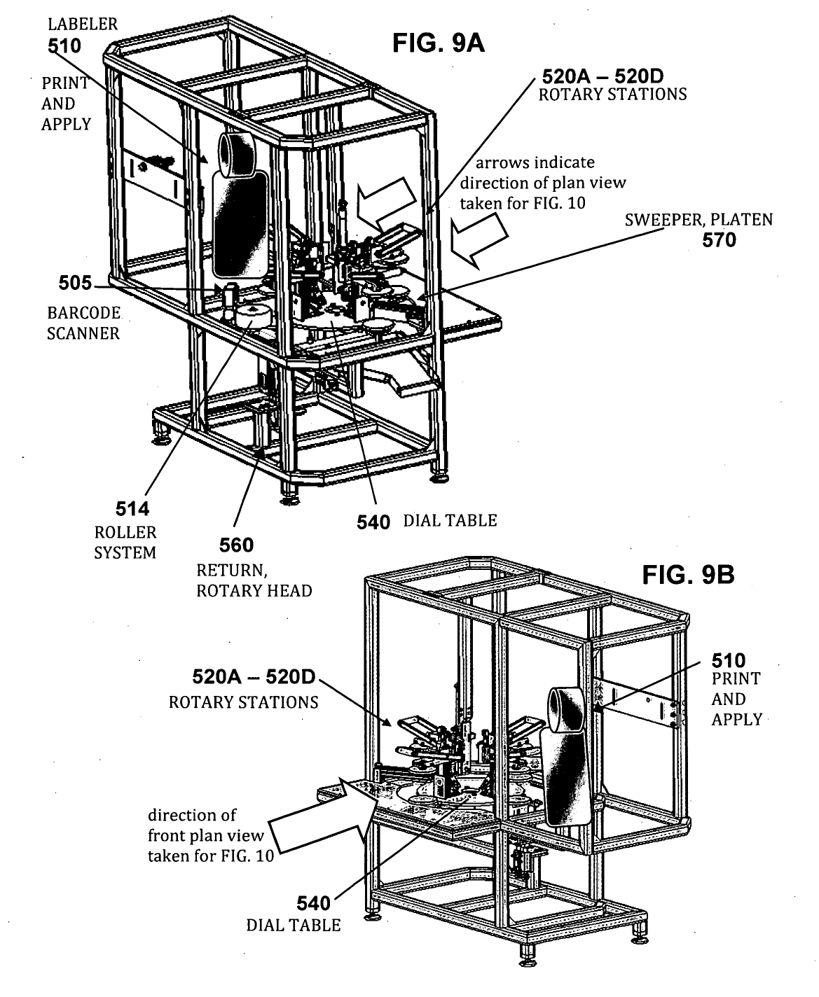

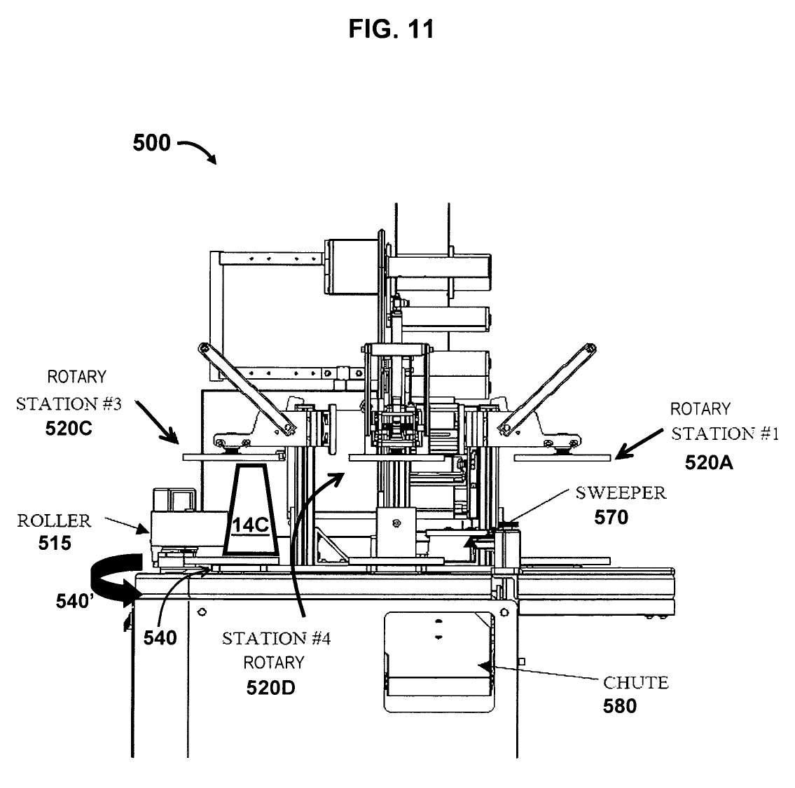

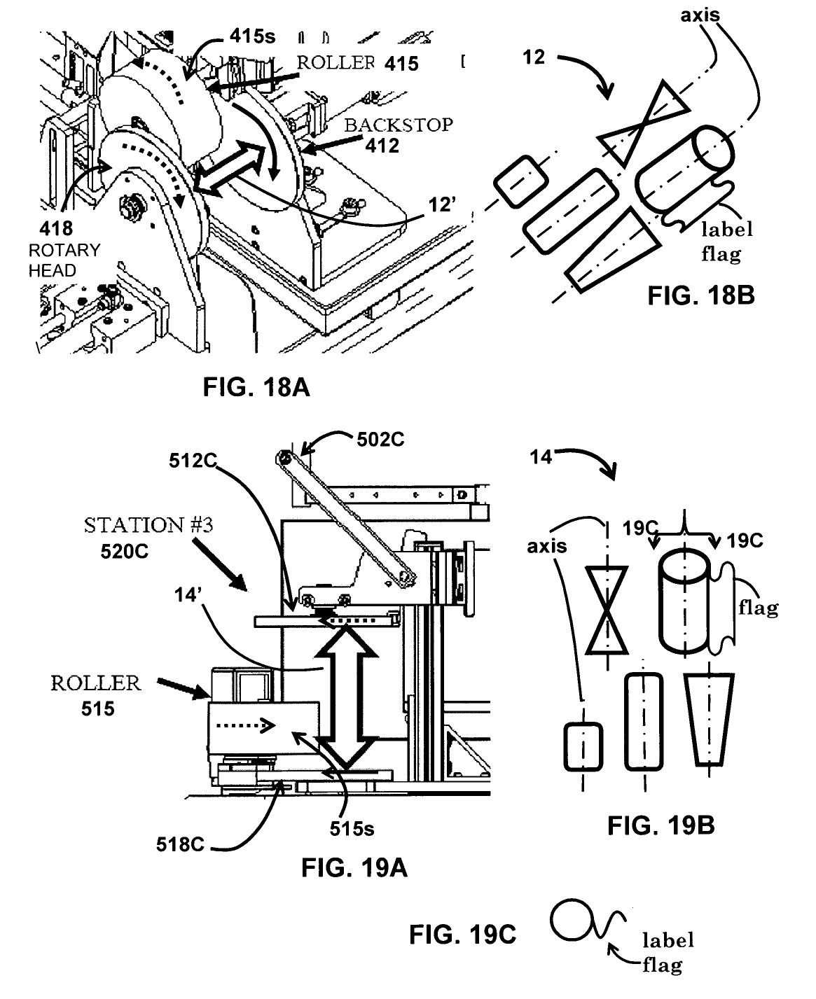

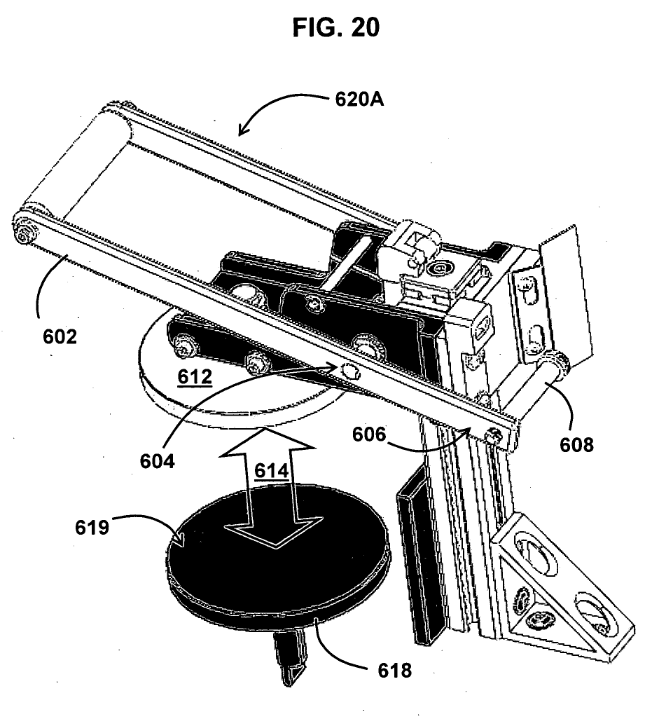

By way of example in FIGS. 1A and 1B, two different ‘routes’ to image capture 331, are represented: One preferred route leads through 200, 300 representing the employ of a novel multi-rotary unit (see, also, FIGS. 9-12 and 19A); and an alternative preferred route leads through a single-rotary station unit 400 (see, also, FIGS. 2, 4-8, and 18A). When a multi-rotary unit is employed (200, 300) such as that at 540 having four rotary stations by may of example: An item is oriented at an initial station such as 520A in FIGS. 11, 12, 13—alternatively at 620A in FIG. 20—so that its major axis is perpendicular to top and bottom platens 512A-D, 518A-D, or 612, 618, between which the item is held during labeling operation; for reference, see FIG. 19A at 14′ as well as FIG. 19B depicting several shapes of items 14, by way of example. When single-rotary unit 400, further detailed in FIGS. 2 and 8, is employed: The item is likewise oriented with its major axis perpendicular to two platens 412, 418 (occasionally referred to, respectively, as “backstop” and “rotary head”); for reference, see also FIG. 18A at 12′ and FIG. 18B depicting several different shaped items 12.

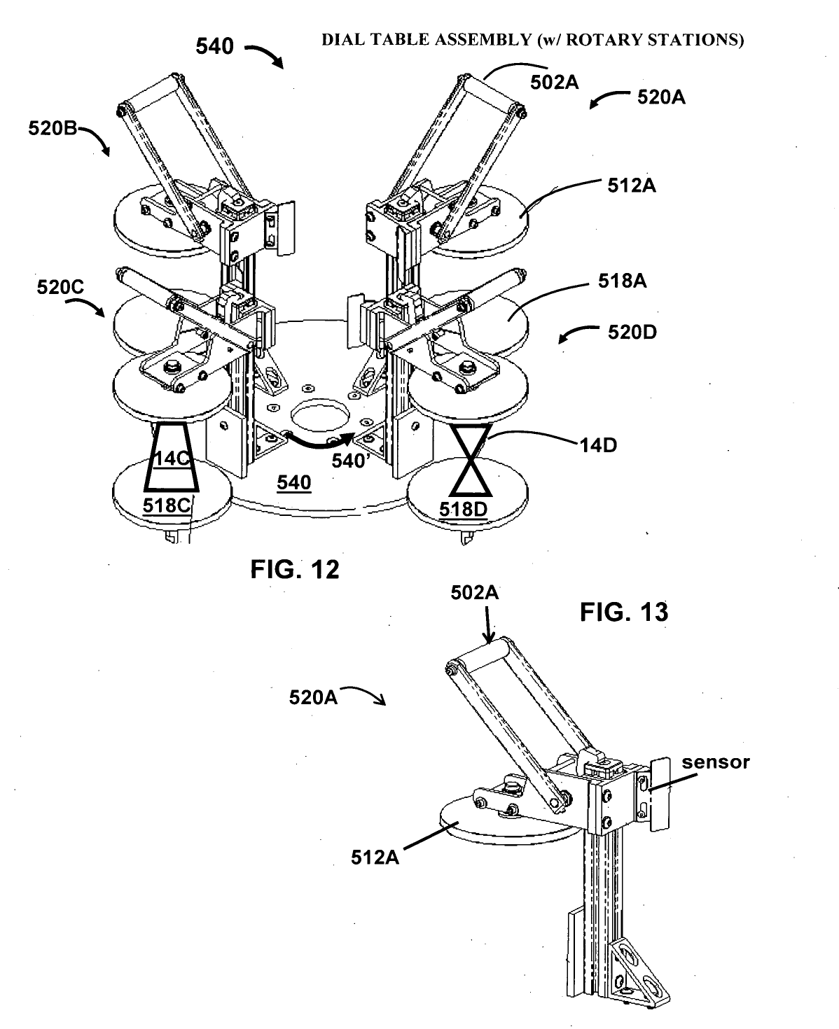

While parallel platen/plate pair 512A-D, 518A-D is oriented in a horizontal direction and parallel platen/plate pair 412, 418 is oriented vertically, and both pairs are shaped as flat circular discs, this orientation and shape is not critical. The parallel plate-member pairs may oriented at an angle with respect to vertical, and/or may be otherwise shaped (square, oblong, or triangular peripheries, or shaped as short-cylinders, rather than plates, etc.), as long as the plate-members can be rotated; e.g., bottom plate 518C and backstop plate 412 each are driven to spin as shown, respectively, by an arrow in FIGS. 8, 18A, and 19A, around an axis of the plate. The other plate-member of the pair—i.e., for 518C this is 512C and for backstop plate 412 it is rotary head plate 418—adapted to ‘freely’ rotate around its axis in the direction of dashed arrows (shown in FIGS. 8, 18A, and 19A) when an item is clamped therebetween (see FIG. 12 at 14D, 14C and FIG. 8 at 12) is driven to spin.

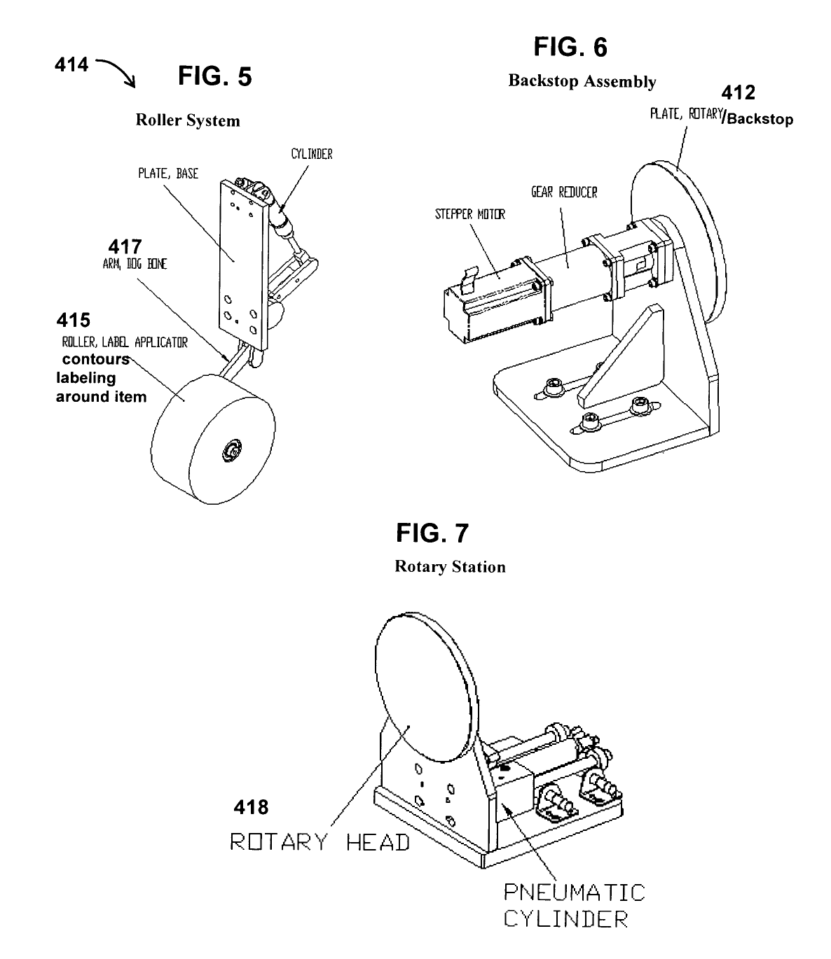

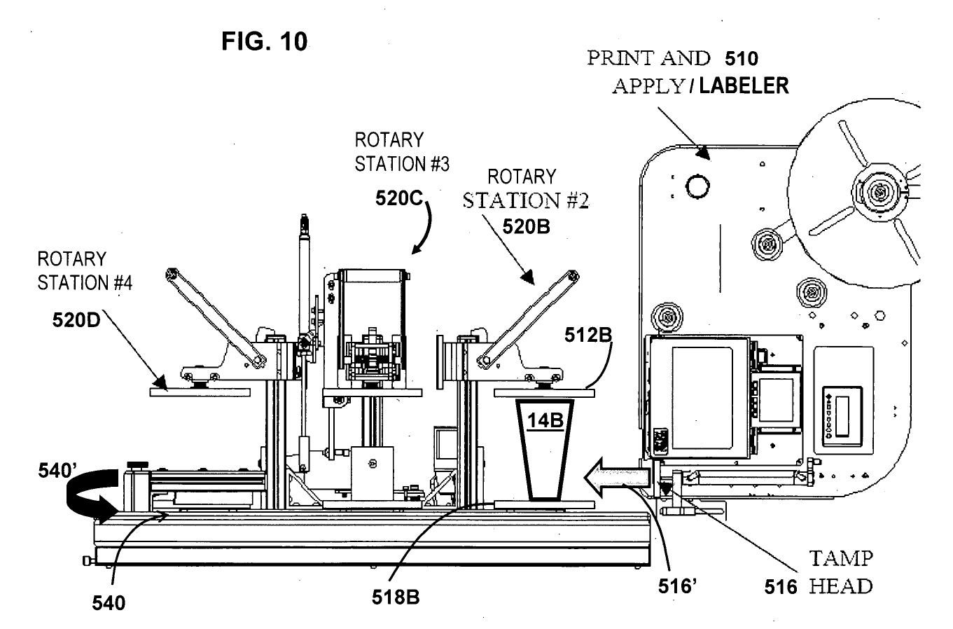

An item is located between an initial rotary station plate-pair (whether this is between 512A, 518A or 412, 512 or 612, 618) so that a desired edge-location of the item is positioned to match-up with an edge of the labeling 210, 410 to be affixed. For example, say the item is a rectangular box, the edge-location of interest could be along its edge; or in the case of the item being a bottle of pills, the edge-location of interest would be, by definition, a curvature. The label/labeling edge is preferably tangentially affixed 200, 400 so as to create a label ‘tail’ (FIG. 1B at 212, 214) for use in the contouring step 330, 430. Affixation of the labeling edge is preferably accomplished by pressure of a tamp head/device (FIG. 10 at 516) that pushes (in the generally direction of 516′) the labeling edge (preferably a sticky-backed/self-adhesive material) against the item edge. When performing, next, the contouring of this labeling ‘tail’ 212, 214 around the periphery of an item, the height/width of the roller 515, 415 is of importance, as is the location of the roller's free-rolling contact surface 515s, 415s from the periphery of the item positioned between the plate-member pair (e.g., FIG. 12 at 14D, 14C and FIG. 8 at 12). The roller 415 as oriented for the single-rotary station unit 400 is further detailed in FIGS. 5, 8, and 18A, and the roller 515 for use in a multi-rotary station unit is further detailed in FIGS. 11, 15, and 19A. A torsion arm 417, 517 is employed to aid in applying sufficiently gentle pressure by the roller's outer rolling surface 415s, 515s. Preferably, the roller is made of a lightweight material—such as a structural foam—having a smooth rolling surface 415s, 515s that will not damage the labeling during contouring thereof around an item.

A computerized unit or units are in communication with the automated pick-and-place robots 100, 140 the rotary station unit, and the image capture device 331 (e.g., a high speed digital camera) to aid in control of the automated process, as well as collect data records as depicted at 250, using a user interface such as a display screen. As represented in FIG. 1C, that same or another set of computerized unit(s) 339 having user interface 350 are, next employed, to aid in carrying out the release/validation step 389. After capturing an image 331 of an item around which a labeling tail 212, 214 has been contoured and affixed (see 380) data records are compared and analyzed, including records made of the image capture 333 of the item as labeled, against records stored of depictions (such as digital images) of a like-kind item without labeling taken prior to being labeled—or taken remotely and forwarded/transmitted to storage 335 for later retrieval—to determine whether the correct labeling has been affixed to an item according to an order received for the item 337. As shown, order records 337 may be for: (1) regulated/controlled medical substance or device such as those which require an order (prescription, Rₓ) originating from a physician, dentist, veterinarian, physical or occupational therapist, and other such licensed ‘provider’ authorized to so order; or (2) non-controlled substances, as well as any other item or batch of items that can be ordered independently by an individual, group, corporate buyer, manufacturer, etc.

In one aspect, each record containing an image capture 331 of an item with labeling affixed is stored 333 as items pass through the system. The digital image of the labeled item is retrieved via computer processor 339 and shown on a screen (or other user interface) 350 along with an associated record retrieved from database 335 containing an image of a like-kind item with no labeling. A visual inspection 383 of the images at 350 may take place on-site or remotely, such as on another floor, in a separate building (e.g., a pharmacy, hospital, out-patient healthcare facility, and so on) in the same or another city, state, or country, by an authorized/licensed user (such as licensed health care provider or other professional) who also is able to retrieve and visually inspect 385 an associated record from those stored 337, of the order for the labeled item(s) in the form of a physician's prescription, or any other order made on-line via the INTERNET, or taken and received by other means. If the correct item has been labeled according to the inspected order 387, it can be released/validated by the authorized/licensed user 389 and transported or transferred 390 to a next-in-line operation such as packing, shipment fulfillment departments, for eventual distribution to the customer (which may be a patient, corporate buyer, manufacturing or design engineer, and so on). If the inspection fails, rejected items can be tagged as such and sent for rework, etc., 388.

FIG. 2 is an isometric of a system having an automated pick-and-place functionality 100, the details of which are labeled and discussed in connection with FIGS. 1A and 3, and a labeling application+contouring functionality 400 (covering over the system apparatus removed so that general locations of certain features are identified: rotary head 418 along with its paired plate-assembly 412 “backstop”; a labeler 410 having conventional components; a roller system 414; and a barcode scanner 405 having conventional features. The identified features are computer controlled. The details of the unit for carrying out the contouring functionality 400 are labeled and discussed elsewhere (see FIGS. 4-8 and 18A).

FIG. 3 is an isometric of the automated pick-and-place functionality 100 shown in FIG. 2, permitting viewing the robot mechanism 120. Two magazine arrays 110A, 110B are lined in parallel, each array having a plurality of bins for vertically stacking items. All of the vertical bins may hold items of similar outer shape with differing contents (e.g., all bottles of similar shape, but having contents of lotion, different types of pills, powders, and so on), or items having different outer shapes (e.g., bottles, boxes, cups, etc.). The robot mechanism is programmed to move out along its linear slide 121 and pick an item to return for placement (item staging/nesting area 130, FIG. 1A) in an initial rotary station 180.

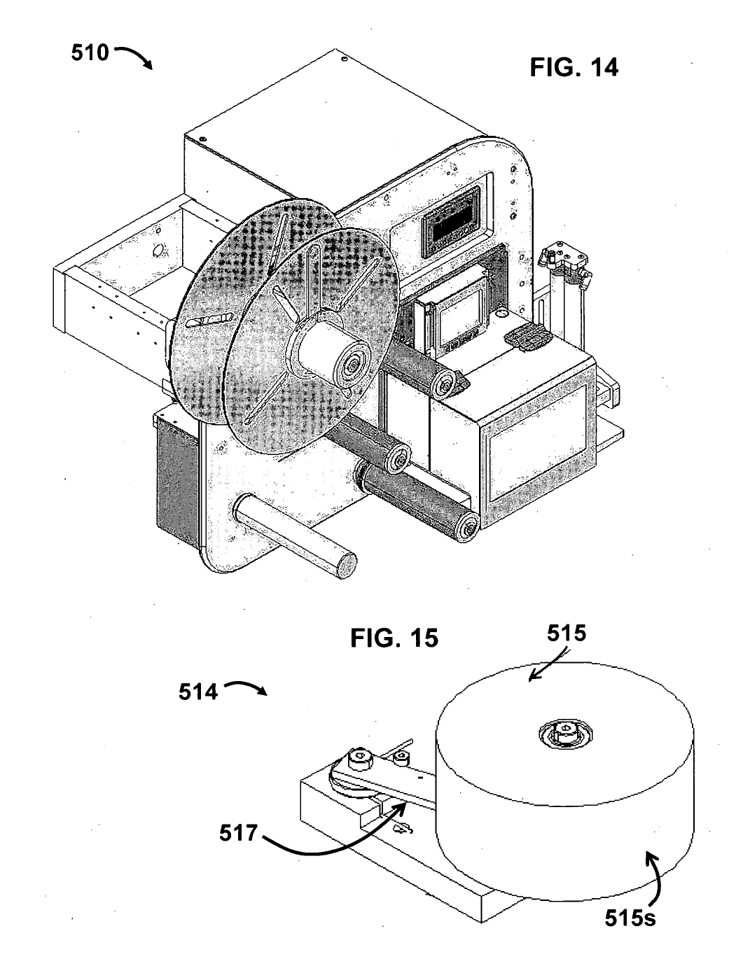

The FIG. 4 plan view looking-in along 4-4 of FIG. 2 permits viewing of features within the labeling and contouring functionality subassembly: rotary head 418 and 412 “backstop”; the labeler 410; a roller system 414; and a barcode scanner/reader 405 for use to identify items having bar-codes printed on an outer surface, before and/or after labeling is applied by the labeler 410; computer access for user input and to monitor and control the system is via suitable user interface 422 (e.g., a touch-sensitive display screen, button panel and/or voice-activated display for accepting commands, and so on). The labeler 410 (see, also, FIG. 8) feeds a printed self-adhesive label/labeling according to an order placed for the item (FIG. 1C, 337). The labeler for both embodiments (FIGS. 1A and 1B at 410, 210 and FIGS. 10 and 14 at 510) may either feed pre-printed labels for applying to each item, or may include a print functionality to print on-demand once an item is identified (barcode scanner 405). Each label/labeling fed for application to an item, whether originating on a roll or sheet, is preferably ‘peeled’ from a backing material before tamp and contouring is performed. As noted 470, an item is held between backstop 412 and rotary head 418 (positioned as detailed, further, at 12 in FIG. 8) during the application of the labeling edge and the contouring around the item of the labeling tail 212, 214. A chute 480 is provided to accept labeled items once finished with label application and contouring (single-rotary station) 430.

FIG. 5 is an isometric of a component identified as a Roller System 414 with features identified, here (and elsewhere); roller 415, connected to a torsion arm 417; a base-plate with attachment holes for securing to support structure of the unit 400.

FIG. 6 is an isometric of a component identified as a Backstop Assembly with the backstop plate-shaped object at 412 further detailed elsewhere. FIG. 7 is an isometric of a component identified as a Rotary Station with a rotary head plate-shaped object at 418, also further detailed elsewhere.

FIG. 8 is an isometric of the selection of components for the single-rotary station labeling application+contouring functionality 400 (see also, FIG. 1) shown also in front plan view in FIG. 4. Procedural aspects include: An item-product 12 is either manually placed (FIGS. 1A, 1B 190), or picked-and-placed/oriented by a robot mechanism (e.g., 120, FIG. 3) and clamped to remain in-place between plate-members 412 and 418. The item is identified so that a dedicated label from labeler 410 can be printed, fed and positioned with a defined labeling-edge aligned with an item-edge on the surface of item 12. A tamp head 416 applies suitable pressure over the aligned labeling-edge to affix it to item 12. Plate-member “backstop” 412 is then driven by a stepper motor to turn in the direction of the solid arrow, which turns item 12 (having been lightly clamped between 412, 418), which in-turn spins rotary head 418 (its axis being free/unrestricted to do so, rotary head 418 spins in the direction shown, dashed arrow). Roller 415 is shown here in an ‘extended’ position so that a free-rolling surface 415s thereof is able to contact and apply suitable pressure to the item surface while being rotated. As the item spins, since the rolling surface 415s in contact with the item, the roller 415 will spin (dashed arrow) to contour the labeling around the periphery of item 12. Once the labeling is affixed around the item, rotary head 418 is retracted (see FIG. 7) which ‘unclamps’ item 12 from between plate-members 412, 418 permitting it to fall into chute 480 for transport to image capture 331 (if not already done as part of 400), and on 380.

FIG. 9 is an isometric of an alternative preferred system (with no automated pick-and-place functionality shown, such as is represented elsewhere at 100 or 140) having a multi-rotary station labeling application+contouring functionality (see also, FIG. 1 at 200, 300, 331 and elsewhere) with portions of the covering over the system apparatus removed for viewing general location of several of the key components. By way of example, shown are the following features (highlighted, elsewhere): a four-rotary station unit having stations 520A-520D atop an assembly “dial table” 540; a label print and apply assembly 510; a roller assembly 514; system rotary/rotary head return 560; a barcode scanner 505 composed of conventional components; a sweeper subassembly 570 for moving labeled items off bottom plate-member 518D once labeled.

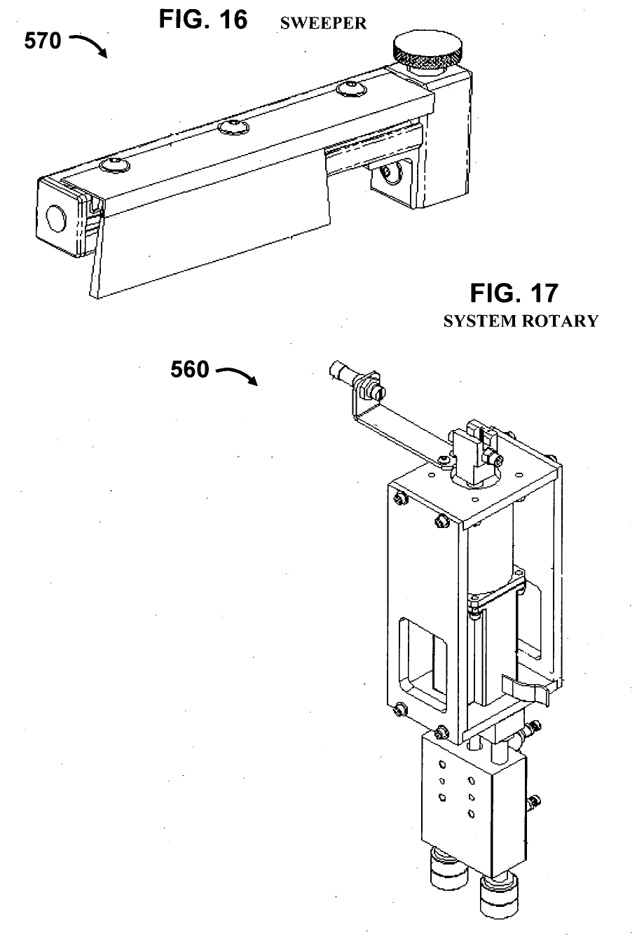

FIGS. 10 and 11 are plan views looking-in, from different perspectives, on the FIG. 9 system apparatus permitting viewing of features of the labeling and contouring functionality stations. The selection of components (see also, FIGS. 9-11) identified as DIAL TABLE ASSEMBLY 540 shown in FIG. 12 provides details of four rotary stations 520A-520D. FIG. 13 is an isometric of the top subassembly of Rotary Station 520A. FIG. 14 is an isometric of the selection of components (see also, FIGS. 9 through 11, and FIGS. 1A, 1B at 210) identified as a LABELER 510. FIG. 15 is an isometric of a Roller system 514 having roller 515 with a free-rolling surface labeled, for reference, 515s. FIG. 16 is an isometric of a SWEEPER 570. FIG. 17 is an isometric of a System Rotary 560 (see also, FIG. 9).

FIG. 18A is a slightly enlarged isometric of a portion of FIG. 8 detailing the single-rotary station, along with an arrow representing the orientation 12′ of an item when undergoing the contouring functionality to contour a label tail around the item. FIG. 18B schematically depicts several items 12, an axis shown for each, representing example shapes of the wide variety to which a labeling may be affixed. FIG. 19A is a slightly enlarged isometric of a portion of FIG. 11 detailing one of the rotary stations (“STATION #3”, 520C), along with an arrow representing the orientation 14′ of an item when undergoing the contouring functionality to contour a label tail around the item. FIG. 19B schematically depicts several items 14, an axis shown for each, representing example shapes of the wide variety to which a labeling may be affixed. FIG. 19C schematically depicts a top plan view (taken at 19C-19C of FIG. 19B) of one of the items 14 having been labeled such that a ‘label flag’ results. FIG. 20 is an isometric—in the form of a digital photo—of an alternate Rotary Station assembly 620A; for comparison, see FIGS. 10, 12, 13, and 19A at 520A-520D. An item is oriented as shown at 614 between plate-member pair 612, 618 atop a surface 619 of bottom member 618 that has been marked (permanently or with a visual display/laser lights originating from above) for aiding in correct orientation of an item 14 (see FIG. 19B) prior to applying pressure to a further unique handle mechanism (composed of handle 602, pivot 604, and a lower extension 606 from which an interior-underarm 608 protrudes) to gently clamp and hold item 14 in position for label affixation and contouring.

Procedural aspects follow by way of back-and-forth reference made to views represented in FIGS. 10-17, as well as 19A, 19B detailing rotary-station 250C, and FIG. 20 detailing rotary-station 620A. As explained above, an item is oriented at an initial location, STATION #1, into rotary-station 520A—alternatively, 620A—so that a major axis of the item is perpendicular to top and bottom platens 512A-D, 518A-D, or 612, 618, between which the item is held 14′, 614 during labeling operation (several shapes of items 14 are shown, by way of example). An operator pulls down on handle 502A—or, in the further unique configuration 620A, FIG. 20 a mechanical lever (not shown) automatically pushes up on interior-underarm 608 to transfer that motion via pivot 604 into a downward push on handle 602—to gently clamp top platen 512A, 612 down on the top portion of the item positioned at 14′, 614 atop lower platen 518A, 618. The clamp is preferably set to hold the item securely in place between the plate-member pair (512A, 518A or 612, 618) during label-edge affixation and contouring operations.

The rotary-station assembly 520A is then moved to the next location (STATION #2). This may be accomplished, for example, by having the operator press a foot switch (not shown for simplicity) or the dial table 540 may be automatically programmed to move in the direction 540′ (assisted by the system rotary assembly 560) to a next station location (e.g., STATION #2). The view in FIG. 10 illustrates components (labeler 510 and tamp head 516) involved in the print and apply functionality: Once either a pre-printed label, or a labeling that is printed on-demand based upon an order received 337, is presented, it is peeled from a backing material (not shown) and a labeling-edge is located and applied against an associated item-edge of item 14B (tamp head extends out and moves labeling-edge in general direction 516′ to place it against the item 14B). The rotary-station 520A is advanced once more (foot pedal or automatically to move dial table 540 in direction 540′) to the next location station (STATION #3). FIG. 11 depicts an item 14C held in place between an associated plate-member pair of rotary-station 520C, and against which roller 515 is begin gently pressed to contour the label tail (212, 214 of FIGS. 1A, 1B) against the item. The roller 515 is mounted to a torsion spring arm 517 set to apply sufficient and gentle force against the item when roller surface 515s is in contact therewith.

The rotary-station is then moved again (via foot pedal or automatically) in direction 540′ to place the labeled item at a new location (STATION #4) so that the handle 502 (602) can be lifted to release the item, permitting the arm of a sweeper mechanism 570 to brush the item gently off plate-member 518D and into a chute 580. The rotary-station is then advanced—of course along with the other three rotary stations—to a next station location, to pick up yet another item.

### EXAMPLE 01

Overview: Areas of use for the unique system and associated method include pick and place and label any odd form product within the Pharmaceutical, Nutraceutical, Cosmetic, General Mail Order and/or Fulfillment industries, scan the manufacturers NDC barcode, print and apply the proper label on-demand and validate label to manufacturer NDC by scanning both barcodes, or capturing an image of labeled item.

### Standard Operating Procedure 01, by Way of Further Example Only:

1.) Proper label size required for products to be run is selected. (Currently up to 2 different label sizes) Label size is determined by customer as to how much of outside packaging of product they wish to cover. It could be as small as ½″ in length and width to as large as necessary to wrap completely around product on all sides and overlap.
2.) Operator then turns on database computer to accept customer order entry. This database then initiates order by telling operator which products are required to fulfill the order for the specific customer.
3.) Operator then manually places & centers each required product separately onto an awaiting platform and closes a holding device which now fixtures product in a specific location. (called assembly, rotary station on Overall drawing)
4.) Operator starts machine which first scans the NDC barcode of the manufacturer and refers to a customer database which matches this NDC to the customer order.
5.) Once the order is confirmed, the print file is sent to the labeler component of the system and a customer specific label is printed and partially removed from the adhesive backing awaiting the presentation of the product. (called label print and apply in Overall drawing)
6.) The product then rotates to arrive at the label station, the label is applied tangentially to the product and the product is rotated around as the label adhesive continues to wrap around the product. Once the label is completely applied to the product, the label machine senses the release of the label and the finished, labeled product is indexed to the next station. (Dial Table Assembly, Labeler print and apply and Roller Station in Overall drawing.)
7.) At the 3^{rd} station, the label barcode is scanned and compared to the manufacturers NDC barcode and to the customer product order in the database to confirm all three match appropriately to validate. (Barcode scanner in Overall drawing.)
8.) If the product is validated, it continues for final packaging, if not product is automatically rejected. (called Sweeper Platen in Overall drawing)

### Standard Operating Procedure 02, by Way of Example Only:

1.) Operator turns on database and accepts entry of customer orders into automated labeling system files.
2.) All various products to be run are pre-loaded into magazine slots. These slots are designed to hold a wide array of differing products from boxes, bottles, apparel, cosmetics, bottled or boxed foodstuff, and so on.
3.) Once the customer order requirement information is downloaded to the labeling system, the machine starts.
4.) The computer system tells a motion control device which products are required to fulfill the order and the products are automatically removed from the shelf or magazine in a specific fashion with the manufacturer's NDC barcode automatically presented to a barcode reader.
5.) Once the NDC barcode is read and confirmed to match the customer order, the product is placed onto a rotary platform and held firm via and overhead bar to keep the product stationary. (If the barcode does not match the customer order, it is automatically rejected.)
6.) Once the product is accepted, a print file of the customer information is automatically sent to the labeling device and the label printed on demand.
7.) The printed label is then partially removed from its adhesive backing and applied automatically tangential to the product.
8.) Once the label edge is applied to the product, the product is automatically rotated via a rotary table on which it was held stationary and the label wraps around the product.
9.) Upon completion of label application to product, the label barcode is read and compared to the manufacturers NDC barcode and the expected product requested via the customer order. If all 3 match, the product is verified and dropped into a tote for final packaging or Pharmacist verification.

### Certain Characteristics of **EXAMPLE 01** Embodiments, Include:

a.) The ability to validate all product manufacturing to product labels to customer order information for 3 point verification.
b.) The ability to automatically label products of non-standard or variable forms in real time. (an ability to handle differing forms of prepackaged products on demand or in real-time high speed production; 3 seconds between products)
c.) The ability to automatically recognize each of the various forms of prepackaged products, along with orientation to confirm manufacturers NDC barcode matches customer requirements prior to label print, order prior to and automatically determine label size necessary to best conform to product.
d.) The ability to automatically partially remove a specific size/shape label from an adhesive backing and apply it tangentially to a product (accomplished by peeling a small portion of the label from the backing and a device applies the portion tangentially to an edge or center, for round or odd shape packages, ie. pills, and rotate the product while holding the label stationary so that it essentially “wraps” the product. How much wrapping is variable based on user identified specification(s).)
e.) The ability to maintain parallelism of label edge to box top/bottom edges/bottle bottom or top cap edges or other products as defined by a plane drawn at the bottom and top surfaces of the prepackaged products relative to the label top and bottom edges. (done via a camera system & algorithms finding tangent points, determining parallelism and using a pliable “foam” style round wheel to press the label onto the product and applying the label while matching the label to the contour of the product.)
f.) The ability to use both standard, 2D, holographic and UV barcode encoded labels within the application and verification process.
g.) The ability to do the variable form print on demand labeling in a high speed, automated production environment. (Reading an order from a customer, scanning a product, producing a label and an operator manually applying it is currently done. The ability to recognize the various forms, print and apply on demand and do all verification against the database and manufactures NDC barcode automatically.)

While certain representative embodiments and details have been shown for the purpose of illustrating features of the invention, those skilled in the art will readily appreciate that various modifications, whether specifically or expressly identified herein, may be made to these representative embodiments without departing from the novel core teachings or scope of this technical disclosure. Accordingly, all such modifications are intended to be included within the scope of the claims. Although the commonly employed preamble phrase “comprising the steps of” may be used herein, or hereafter, in a method claim, the applicants do not intend to invoke 35 U.S.C. §112 ¶6 in a manner that unduly limits rights to their innovation. Furthermore, in any claim that is filed herewith or hereafter, any means-plus-function clauses used, or later found to be present, are intended to cover at least all structure(s) described herein as performing the recited function and not only structural equivalents but also equivalent structures.

We claim:

1. A system for labeling a plurality of items, each having a periphery, the system comprising:
(a) a rotary-station comprising a pair of plate-members each having a rotation axis, said pair adapted for holding each of the plurality of items, individually;
(b) a labeler assembly for providing a plurality of dedicated labeling;
(c) a mechanism for applying a labeling-edge of a first of said dedicated labeling to a first item of the plurality of items, leaving a first labeling tail, while holding said first item between said pair of plate-members; and
(d) a roller for contouring said first labeling tail around at least a portion of the periphery of said first item by making contact between a rolling surface and said first labeling tail while said first item moves in a spinning fashion.

2. The system of claim 1, further comprising:
(a) a pick-and-place robot mechanism for orienting said first item between said pair of plate-members prior to said holding;
(b) said labeler assembly comprising a printer for creating said dedicated labeling;
(c) a computerized inspection apparatus for image capture of said first item to which said dedicated labeling has been applied.

3. The system of claim 1, wherein said rotary-station is fixed at a first location while: said labeler assembly provides said dedicated labeling, said labeling-edge is applied, and said first labeling tail is contoured around said portion of the periphery of said first item.

4. The system of claim 1, wherein:
(a) further comprising a table assembly, adapted for rotation, to which said rotary-station is secured; and
(b) said first item is oriented between said pair of plate-members at a first station location, and upon rotational movement of said table assembly, said first item oriented between said pair of plate-members is moved into a second station location for application of said labeling-edge of said first dedicated labeling.

5. The system of claim 4, wherein: once said labeling-edge is applied, upon rotational movement of said table assembly, said first item oriented between said pair of plate-members is moved into a third station location for said contouring said first labeling tail.

6. The system of claim 1:
(a) further comprising:
a second rotary-station comprising a second pair of plate-members each having a rotation axis; and
a table assembly, adapted for rotation, to which said first and second rotary-stations are secured; and
(b) wherein said first item is oriented between said first pair of plate-members at a first station location, and then moved into a second station location for application of said labeling-edge of said first dedicated labeling.

7. The system of claim 1:
(a) further comprising:
a second rotary-station comprising a second pair of plate-members each having a rotation axis;
a third rotary-station comprising a third pair of plate-members each having a rotation axis; and
a table assembly, adapted for rotation, to which said first, second, and third rotary-stations are secured; and
(b) wherein:
said first item is oriented between said first pair of plate-members at a first station location, and then moved into a second station location; and
a second item of the plurality of items is oriented between said second pair of plate-members at said first station location while said first rotary-station is at said second station location.

8. The system of claim 7 wherein: once said second item oriented between said second pair of plate-members is moved into said second station location and said first item oriented between said first pair of plate-member is moved into a third station location, a third item of the plurality of items is oriented between said third pair of plate-members at said first station location while said second rotary-station is at said second station location and said first rotary-station is at said third station location.

9. The system of claim 1, wherein the periphery of at least a first, second, and third item of the plurality of items, are different from one another.

10. A method for labeling a plurality of items, each having a periphery, the method comprising the steps of:
(a) orienting a first item of the plurality of items between a pair of plate-members each having a rotation axis;
(b) automatically providing a first of a plurality of dedicated labeling;
(c) while holding said first item between said pair of plate-members, applying a labeling-edge of said first dedicated labeling to said first item, leaving a first labeling tail; and
(d) contouring said first labeling tail around at least a portion of the periphery of said first item by making contact between a rolling surface and said first labeling tail while said first item moves in a spinning fashion along with said pair of plate-members.

11. The method of claim 10, wherein said rotary-station is fixed at a first location while said steps of automatically providing said first dedicated labeling, applying said labeling-edge to said first item, and contouring said first labeling tail around at least a portion of the periphery, are performed.

12. The method of claim 10, wherein:
(a) said orienting said first item between said pair of plate-members is performed at a first station location;
(b) said applying said labeling-edge to said first item is performed at a second station location while still holding said first item between said pair of plate-members; and
(c) said contouring said first labeling tail is performed at a third station location while still holding said first item between said pair of plate-members.

13. The method of claim 12, wherein movement from said first station to said second station and from said second station to said third station are performed by rotating a table assembly to which a first rotary-station comprising said pair of plate-members, has been secured.

14. The method of claim 10, further comprising the steps of:
(a) orienting a second item of the plurality of items between a second pair of plate-members each having a rotation axis; and
(b) orienting a third item of the plurality of items between a third pair of plate-members each having a rotation axis.
